(19) United States
(12) Patent Application Publication
(10) Pub. No.: US 2007/0067968 A1
(43) Pub. Date: Mar. 29, 2007

(54) Connectable Bungee Cord

(76) Inventor: Joseph Krawczyk, Orlando, FL (US)

Correspondence Address: James H. Beusse, Esquire;Beusse Wolter Sanks Mora & Maire, P.A., Suite 2500, 390 North Orange Avenue, Orlando, FL, 32801, US

(21) Appl. No.: 11/535,548

(22) Filed: Sep. 27, 2006

Related U.S. Application Data
(60) Provisional application No. 60/720,846, filed on Sep. 27, 2005.

(51) Int. Cl. F16B 45/00

(52) U.S. Cl. 24/300

(57) ABSTRACT

A bungee cord fastener includes a hook portion and a receptacle formed in the hook portion for receiving a mating portion of another bungee cord fastener therein. The receptacle is configured for providing a frictional fit of the mating portion within the receptacle sufficient to allow sliding insertion of the mating portion into the receptacle and sliding removal of the mating portion from the receptacle while limiting inadvertent slipping of the mating portion out of the receptacle.

### SPECIFIC DATA RELATED TO THE INVENTION

This application claims the benefit of U.S. Provisional Application No. 60/720,846 filed Sep. 27, 2005.

### FIELD OF THE INVENTION

The invention generally relates to bungee cords, and, more particularly, to a bungee cord fastener having a receptacle for receiving a mating portion of another bungee cord fastener.

### BACKGROUND OF THE INVENTION

Elastic cords, commonly known as bungee cords, are especially suited for securing items, such as tying down cargo being transported. Bungee cords typically include an elastic member, such as an encased bundle of elastic strands or a solid elastic band, having two fasteners at opposite ends for securing the cord to itself or a convenient securing point. The fasteners may be formed from a steel wire in a “J” or “S” shaped configuration that includes a hook portion for releasably engaging a securing point, such as a cargo tie down point of a luggage rack or a portion of the cord itself. Typically, tension must be maintained on the cord to keep the hook portion attached to the securing point.

### BRIEF DESCRIPTION OF THE DRAWINGS

FIG. 1 shows a perspective view of an example bungee cord fastener including a receptacle for receiving a mating portion of another bungee cord fastener.

FIG. 2 shows mating bungee cord fastener installed in the receptacle of the bungee cord fastener of FIG. 1.

FIG. 3 shows another example embodiment of a bungee cord fastener having a connection receptacle.

FIG. 4 shows another example embodiment of a bungee cord fastener connection receptacle.

FIG. 5 shows another example embodiment of a bungee cord fastener connection receptacle.

FIG. 6 shows another example embodiment of a bungee cord fastener including a receptacle and having a mating portion of another bungee cord fastener installed therein.

FIG. 7 shows another example embodiment of a bungee cord fastener including a coating.

### DETAILED DESCRIPTION OF THE INVENTION

Although bungee cords are useful for tightly securing items without using knots or tightening hardware, different sized items require the use of different length bungee cords. While bungee cords may be hooked together by engaging their respective hooked portions, the hooked portions typically only remain engaged while applying a force to one or more of the hooks to keep them engaged. For example, when using multiple bungee cords connected by their hooked portions to secure cargo to the top of a car, one end of the connected bungee cords must be released to pass the connected cords over the top of the cargo to the other side of the car, typically resulting in the cords becoming disconnected due to lack of tension being applied throughout this activity. In addition, when cords are strung together in this manner, the engaged hook portions do not lie in the same plane, resulting in a tendency of the hooks to snag items being secured.

The present invention provides an innovative bungee cord fastener having a receptacle formed in the hook portion of the fastener for receiving a mating portion of another bungee cord fastener therein and for providing a frictional fit of the mating portion within the receptacle sufficient to allow sliding insertion of the mating portion into the receptacle and sliding removal of the mating portion from the receptacle while limiting inadvertent slipping of the mating portion out of the receptacle, for example, when using the connected cords to secure an item.

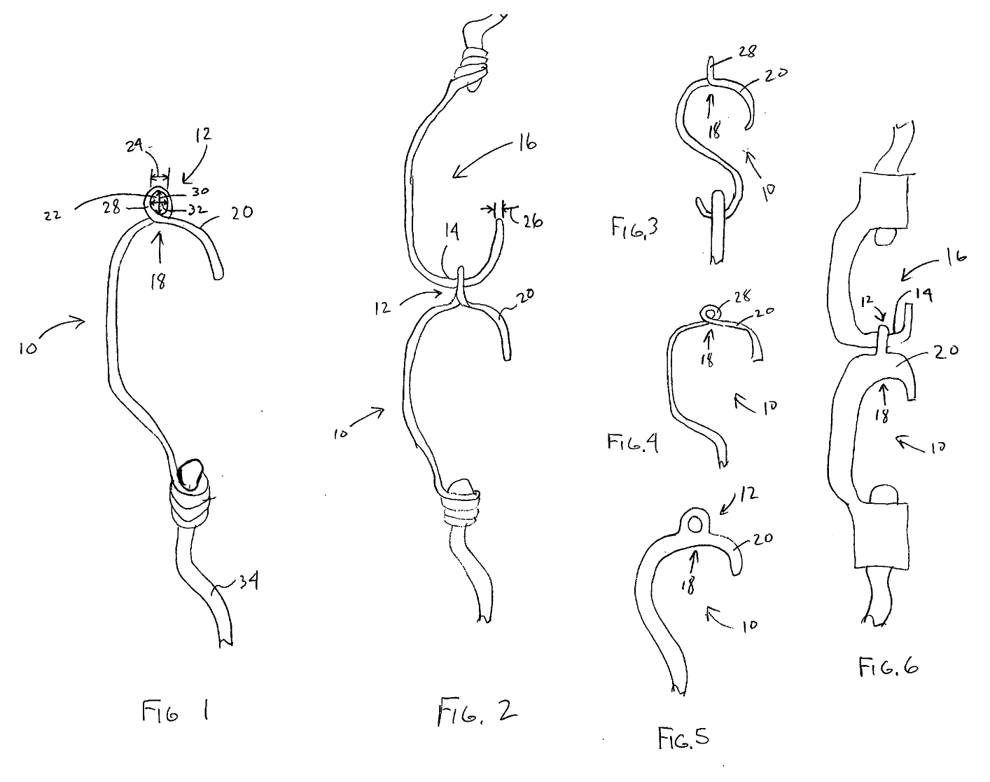

FIG. 1 shows a perspective view of an example bungee cord fastener 10 including a receptacle 12 for receiving a mating portion 14 of another bungee cord fastener 16, such as a conventional bungee cord fastener, as depicted in FIG. 2. The receptacle 12 may be located at a top 18 of a hook portion 20 of the fastener 10 and may be oriented outwardly from the top 18 of the hook portion 20. As shown in FIG. 2, the receptacle 12 may be oriented substantially perpendicular to a plane of the hook portion 20 so that the connected fasteners 10, 18 remain generally aligned in the same plane.

In an aspect of the invention, the receptacle 12 may be configured for providing a frictional fit of the mating portion 14 within the receptacle 12 sufficient to allow sliding insertion of the mating portion 14 into the receptacle 12 and sliding removal of the mating portion 14 from the receptacle 12 while limiting inadvertent slipping of the mating portion 14 out of the receptacle 12. For example, a frictional fit may be provided by an sizing the aperture 22 of the receptacle 12 slightly larger than the mating portion 14 of the fastener 16 being retained in the receptacle 12 yet small enough to prevent the mating portion 14 from becoming unintentionally dislodged from the receptacle 12, so that sufficient friction is generated between an inner surface of the receptacle 12 and a contacting surface of the mating portion 14 to limit inadvertent withdrawal of the mating portion 14.

In the example embodiment depicted in FIGS. 1 and 2, the fasteners 10, 16 may be formed from metal wire. The receptacle 12 may include a loop 28 formed in the top 18 of the hook portion 20 of the fastener 10 to define the aperture 22. The loop 28 may be geometrically sized to define an aperture 22 having a diameter 24 slightly larger than a diameter 26 of the wire of the fastener 16 installed in the receptacle 12. The loop 28 may be oriented substantially perpendicularly with respect to a plane of the hooked portion 24 so that the end hooks 12, 14 lie flat when connected. In an example embodiment, the diameter 26 of the aperture 22 defined by the loop 28 may be about 4 millimeters (mm) to frictionally retain a hook 16 having a wire diameter of about 3.4 mm. In another embodiment, the aperture 22 defined by the loop 28 may include an oval cross section having a major axis 30 oriented away from of the top 18 of the hook portion 20. To accommodate a hook 16 having a wire diameter of about 3.4 mm, the oval may be sized to have a major axis of about 6 mm, and a minor axis 32 of about 4 mm.

A bungee cord having the fastener 10 depicted in FIG. 1 attached to one end of an elastic member 34 may include a fastener, such as the fastener 16 shown in FIG. 2, that is configured for mating with the receptacle 12 of fastener 10 attached to an opposite end of the elastic member 34. This bungee cord configuration allows two or more of the bungee cords to be strung together to provide a desired overall length. For example, bungee cords in one foot lengths may be connected together to form a connected cord having one foot increments, thereby reducing a need to have an inventory of different length bungee cords. In addition, cords may be folded in half on themselves to form, for example, half foot increments.

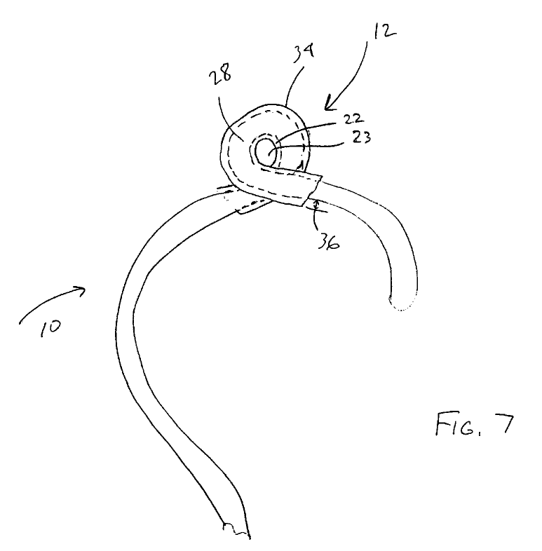

FIGS. 3-6 show various example embodiments of bungee cord fasteners including connection receptacles. FIG. 3 shows an “S” shaped metal wire fastener 10 having a loop 28 formed in the top 18 of the hook portion 20. FIG. 4 shows a metal wire fastener 10 having loop 28 formed in the top 18 of the hook portion 20 in the same plane as the hook portion. FIG. 5 shows a fastener 10 formed from flat stock, such as flat metal or flat plastic, having a receptacle 12 formed in the top 18 of the hook portion 20 in the same plane as the hook portion 20. Alternatively, the receptacle 12 may be rotated substantially perpendicularly to the plane of the hook portion 20. FIG. 6 shows fasteners 10, 16 formed from plastic, wherein fastener 10 includes a receptacle 12 formed in the top 18 of the hook portion 20 for frictionally retaining mating portion 14 of fastener 16.

In an embodiment of the invention, the receptacle 12, or a portion thereof, may include a surface finish or a coating for providing a degree of frictional resistance to removal of a mating portion 14 (see, for example, FIG. 2) from the receptacle 12. In an example embodiment, the surface finish may include a roughened finish. In another example embodiment, the coating may include an elastomeric material. In a metal wire fastener 10 embodiment depicted in FIG. 7, a coating 34 is shown applied over the loop 28. The geometry of the loop 28, such as a size of the aperture 22 of the loop 28, may need to be configured to account for a thickness 36 of the coating 34, so that an aperture 23 defined by the coating 34 on the loop 28 is sized to allow sliding insertion of a mating portion 14 into the receptacle 12. In addition, the aperture 23 is sized to allow sliding removal of the mating portion 14 from the receptacle 12 while limiting inadvertent slipping of the mating portion 14 out of the receptacle 12 due, at least in part, to the degree of frictional resistance provided by the coating 34. Other fastener 10 embodiments, such as the embodiments depicted in FIGS. 3-6, may include a surface finish or a coating applied to the receptacle 12, or portions thereof, to provide a degree of frictional resistance.

While various embodiments of the present invention have been shown and described herein, it will be obvious that such embodiments are provided by way of example only. Numerous variations, changes and substitutions may be made without departing from the invention herein.

I claim:

1. A bungee cord fastener comprising:
a hook portion; and
a receptacle formed in the hook portion for receiving a mating portion of another bungee cord fastener therein and for providing a frictional fit of the mating portion within the receptacle sufficient to allow sliding insertion of the mating portion into the receptacle and sliding removal of the mating portion from the receptacle while limiting inadvertent slipping of the mating portion out of the receptacle.

2. The fastener of claim 1, wherein the receptacle is located at a top of the hook portion.

3. The fastener of claim 2, wherein the receptacle is oriented outwardly from the top of the hook portion.

4. The fastener of claim 1, wherein the receptacle is oriented substantially perpendicular to a plane of the hook portion.

5. The fastener of claim 1, wherein the receptacle comprises an aperture formed in the hook portion sized to receive the mating portion therein.

6. The fastener of claim 5, wherein the aperture comprises an aperture dimension slightly larger than a dimension of the mating portion.

7. The fastener of claim 5, wherein the fastener is formed from a metal wire.

8. The fastener of claim 7, wherein the aperture is defined by a loop formed in the metal wire.

9. The fastener of claim 8, wherein the loop comprises an oval cross section.

10. The fastener of claim 1, wherein the end hook is formed from plastic.

11. The fastener of claim 1, wherein at least a portion of the receptacle comprises a surface finish for providing a degree of frictional resistance to removal of the mating portion from the receptacle.

12. The fastener of claim 1, wherein at least a portion of the receptacle comprises a coating for providing a degree of frictional resistance to removal of the mating portion from the receptacle.

13. The fastener of claim 12, wherein the coating comprises an elastomeric material.

14. A bungee cord fastener comprising:
a hook portion formed from a metal wire; and
a loop formed in the wire at a top of the hook portion for receiving a mating portion of another bungee cord fastener therein and for providing a frictional fit of the mating portion within the loop sufficient to allow sliding insertion of the mating portion into the loop and sliding removal of the mating portion from the loop while limiting inadvertent slipping of the mating portion out of the loop.

15. The fastener of claim 14, wherein at least a portion of the loop comprises a surface finish for providing a degree of frictional resistance to removal of the mating portion from the loop.

16. The fastener of claim 14, wherein at least a portion of the loop comprises a coating for providing a degree of frictional resistance to removal of the mating portion from the loop.

17. The fastener of claim 16, wherein the coating comprises an elastomeric material.

18. The fastener of claim 14, wherein the loop is oriented substantially perpendicular to a plane of the hook portion.

19. An elastic cord comprising:
an elastic member;
a fastener attached to an end of the elastic member having a hook portion; and
a receptacle formed in the hook portion for receiving a mating portion of another bungee cord fastener therein and for providing a frictional fit of the mating portion within the receptacle sufficient to allow sliding insertion of the mating portion into the receptacle and sliding removal of the mating portion from the receptacle while limiting inadvertent slipping of the mating portion out of the receptacle.
